(19) United States
(12) Patent Application Publication
(10) Pub. No.: US 2007/0154724 A1
(43) Pub. Date: Jul. 5, 2007

(54) Heat-shielding laminated glass

(76) Inventors: Takashi Muromachi, Minato-ku (JP); Hisashi Ogawa, Minato-ku (JP); Nobuki Iwai, Minato-ku (JP)

Correspondence Address: RATNERPRESTIA, P O BOX 980, VALLEY FORGE, PA, 19482-0980, US

(21) Appl. No.: 10/578,789

(22) PCT Filed: Nov. 10, 2004
(86) PCT No.: PCT/JP04/16671

§ 371 Date: Feb. 21, 2007

(30) Foreign Application Priority Data
Nov. 10, 2003 (JP) 2003-379253

(51) Int. Cl. B32B 17/06

(52) U.S. Cl. 428/426; 428/432

(57) ABSTRACT

A heat-shielding laminated glass that excels in an infrared radiation shielding performance, exhibiting high transparency, and that is available at low cost even in the use of ITO microparticles as infrared radiation shielding microparticles. There is provided a heat-shielding laminated glass comprising multiple glass plates and, interposed between any glass plates, interlayers, wherein each of the multiple glass plates is a UV cut green glass of 1.4 to 2.5 mm thickness, total iron content thereof being in the range of 0.6 to 1.2% by weight in terms of Fe₂O₃, the green glass containing FeO in an amount, in terms of Fe₂O₃, of 15 to 40% based on the total iron, and wherein ITO microparticles with an average particle diameter of≦0.2 μm are dispersed in the interlayers, the ITO microparticles amounting to 0.4 to 0.8 g/m²

### FIELD OF THE INVENTION

The present invention relates to a laminated glass, particularly to a laminated glass that excels in an infrared radiation shielding performance, exhibits high transparency, and is available at low cost.

### BACKGROUND ART

Laminated glasses formed by laminating multiple glass plates and an interlayer film such as a polyvinyl butyral resin film have been used so far, for instance as a window panel of a motor vehicle. Laminated glasses further provided with additional functions are also known, the additional functions being heat insulation and electromagnetic wave transmittance by dispersing functional microparticles in the interlayer, and the like.

For example, a laminated glass that is provided with an infrared radiation shielding performance and excels in appearance is disclosed in Japanese Patent Publication No.151,539/2001. According to the invention thereof, the laminated glass having an interlayer film with infrared radiation shielding microparticles (not more than 0.2 μm in diameter) dispersed therein comprises glass plates consisting of soda lime silica glass containing iron. By controlling the amount of the iron content appropriately, a laminated glass of a desirable infrared radiation shielding performance can be obtained. In this case, it is possible to prevent an adverse effects on the appearance of a laminated glass by limiting the proportion of the infrared radiation shielding microparticle content, and to obtain a desirable infrared radiation shielding performance at the same time.

Further, by controlling appropriately the amount of the FeO content in said soda lime silica glass containing iron, it is possible to shield, to a satisfactory extent, the light in the far-infrared range with the infrared radiation shielding microparticles and to shield, to a satisfactory extent, the light of a wavelength around 1100 nm, where the shielding performance comes down, by limiting the proportion of the infrared radiation shielding microparticle content. In addition, by controlling the FeO content, the light of a wavelength around 850 nm can be transmitted, which is sufficient for the operation of various types of infrared radiation sensor systems (e.g. an automatic accounting system).

As another example, a laminated glass that has a heat-shielding performance by cutting the infrared light in the wavelength range of 1,000-1,100 nm and allows good operation of an infrared radiation communication system by transmitting the light of a wavelength around 850 nm is disclosed in Japanese Patent Publication No.173346/2002. According to the invention thereof, the laminated glass having an interlayer film with infrared radiation shielding micro-particles, 0.2 μm or less in diameter, dispersed therein comprises glass plates each consisting of soda lime silica glass containing iron. By controlling the amount of said iron content appropriately, a laminated glass of a desirable infrared radiation shielding performance can be obtained.

Additionally, it is possible in this laminated glass to lessen the haze by limiting the proportion of the infrared radiation shielding microparticle content, reducing adverse effects on the appearance of the window glass. Further, by controlling the proportion of the infrared radiation shielding microparticle content, transmittance of the infrared light having a wavelength around 850 nm, which is used for the operation of an infrared radiation communication system (e.g. an optical beacon of VICS and a keyless entry system), can be ensured.

In these publications, the lower limit of the amount of the infrared radiation shielding microparticles dispersed in the interlayer film is 0.836 g/m², assuming the relative density of the interlayer film to be 1.1. As an infrared radiation shielding microparticle, indium tin oxide (ITO), a complex oxide containing indium oxide and tin oxide at the approximate weight ratio of 9 to 1, is commonly used because of its excellent infrared radiation shielding performance. However, ITO microparticles being expensive, there is a disadvantage that the finished laminated glass will be expensive, even though it contains the microparticles of said lower limit of 0.836 g/m².

Thus, it is desirable to provide a laminated glass that allows as much infrared radiation shielding performance even when the amount of the infrared radiation shielding microparticles is less than the lower limit described in these publications mentioned above.

### DESCRIPTION OF THE INVENTION

It is an object of the present invention to provide a laminated glass that excels in an infrared radiation shielding performance, exhibiting high transparency, and particularly that is available at low cost even in the use of ITO microparticles as infrared radiation shielding microparticles.

The present invention is intended to solve the above problems and characterized in that the laminated glass comprises a plurality of glass plates and interlayers interposed between any glass plates, wherein each of the plurality of glass plates is a UV cut green glass of 1.4 to 2.5 mm thickness, total iron content thereof being in the range of 0.6 to 1.2% by weight in terms of Fe₂O₃, the green glass containing FeO in an amount of 15 to 40% in terms of Fe₂O₃ based on the total iron, and wherein ITO microparticles with an average particle diameter of 0.2 μm or less are dispersed in the interlayers, ITO microparticles amounting to 0.4 to 0.8 g/m².

### BRIEF DESCRIPTION OF THE DRAWING

FIG. 1 is a graph illustrating the spectral transmission factors in the embodiments and the comparative example.

### BEST MODE FOR CARRYING OUT THE INVENTION

A laminated glass according to a preferred embodiment of the present invention has a laminated structure, in which an interlayer is interposed between two glass plates. As an interlayer contained in the laminated glass, the kinds of vinyl-based resins that are commonly used in laminated glasses, such as polyvinyl butyral (PVB) resin and ethylene-vinyl acetate copolymer resin, can be used. The infrared radiation shielding microparticles with an average particle diameter of up to 0.2 μm are dispersed in the interlayer. In this way, the average particle diameter of infrared radiation shielding microparticles is preferable to be 0.2 μm or less, and more preferable to be 0.1 μm or less, since a microparticle having average diameter larger than 0.2 μm or a bulky cluster of coagulated microparticles becomes scatter sources in the formed interlayer, causing haze therein.

As infrared radiation shielding particles, metals, oxides, nitrides and sulfides of Sn, Ti, Si, Zn, Zr, Fe, Al, Cr, Co, Ce, In, Ni, Ag, Cu, Pt, Mn, Ta, W, V and Mo can be used, as well as doped materials formed by doping these materials with Sb or F. Also, each of these microparticles in itself and compounds of these microparticles can be used. Further, by using a mixture formed by mixing each of these microparticles in itself or compounds with organic resin or a coated material formed by coating organic resin, various performances required for architecture or motor vehicles can be obtained.

As infrared radiation shielding microparticles, it is desirable to use indium tin oxide (ITO), or a complex oxide containing indium oxide and tin oxide at the approximate weight ratio of 9 to 1, because of its excellent infrared radiation shielding performance. However, ITO microparticles being expensive, it is desirable to achieve a desired heat-shielding performance with as small blending quantity of ITO microparticles as possible to make the finished laminated glass product competitive in price. Further, since the haze in the an interlayer generally increases proportionally to the blending quantity of ITO microparticles, it is preferred to limit the blending quantity of ITO microparticles to keep the haze in the interlayer at a low level.

Accordingly, the quantity of ITO microparticles added is preferred to be in the range of 0.4 g/m² to 0.8 g/m². In case of said quantity being less than 0.4 g/m², the heat-shielding performance may fall down, while in case of more than 0.8 g/m², the laminated glass product will be expensive. A desired infrared radiation shielding performance can be obtained in this manner with relatively small amount of ITO microparticles, so that the laminated glass product is available at low cost as well as the haze in the interlayer stays at a low level.

The measurement of the amount of ITO microparticles (0.4 g/m² to 0.8 g/m²) contained in the interlayer was taken in the method of:
cutting the interlayer in the size of about 1 by 6 cm,
dissolving the interlayer by using an acid, and
determining the quantity of Sn and In by using the plasma emission spectrometry method.

An interlayer containing ITO microparticles in the amount of 0.4 g/m² to 0.8 g/m² can be obtained for example as follows:
ITO microparticles dispersed in an plasticizer is kneaded into PVB resin with a roll mixer, and
the resin material is melted, and then formed and shaped by an extrusion machine into a sheet-shaped interlayer.

In order to disperse ITO microparticles well in the vinyl-based resin, it is conceivable to add ITO microparticles to the vinyl-based resin with an plasticizer containing ITO microparticles dispersed therein. Materials commonly used for the interlayers can be used as an plasticizer, singularly or plurally. Specifically, triethylene-glycol-di-2-ethylhexanoate (3GO), triethyleneglycol-di-2-ethylbutylate (3GH), dihexiladipate (DHA), tetraethylene-glycol-di-heptanoate (4G7), tetraethyleneglycol-di-2-ethylhexanoate (4GO), and triethyleneglycol-di-heptanoate (3G7) are for instance preferably used. The added quantity of these plasticizers is preferred to be of 30 to 60 weight parts relative to 100 weight parts of the vinyl-based resin.

Other additive agents can also be added to the vinyl-based resin. Among such additive agents are for instance various kinds of colorants, ultraviolet absorbers and light stabilizers. A benzotriazole based absorber is for instance used preferably as a ultraviolet absorber, not to be confined thereto though. Specifically, ‘Tinuvin P’ by Ciba-Geigy Co., Ltd. can be used. A hindered amine based material is for instance preferably used as a light stabilizer, not to be confined thereto though. Specifically, ‘Adekastab LA-57’ by Asahi Denka Co., Ltd. can be used.

In forming an interlayer according to the present invention, known methods such as calendar roll method, extrusion method, casting method and inflation method can be used. Particularly, in case of using an interlayer comprising vinyl-based resin material as an interlayer for the laminated glass of the present invention, ITO microparticles are added to the vinyl-based resin and kneaded into uniform dispersion, and the vinyl-based resin material being conditioned in this way can be formed into a sheet-shape. In forming the vinyl-based resin material into a sheet-shape, a heat stabilizer and an antioxidant may be blended therein as needed, as well as an adhesivity adjusting material such as metallic salt for strengthening the penetrability of the sheet.

In a laminated glass according to the present invention, it is preferred to use UV cut green glasses in order to limit the blending amount of ITO microparticles. As these UV cut green glasses, for instance, those having the glass composition (wt %, when having 2.0 mm thickness) of 70.6% SiO₂, 1.6% Al₂O₃, 3.1% MgO, 8.2% CaO, 14.1% Na₂O, 0.6% K₂O, 0.73% Fe₂O₃, 0.04% TiO₂ and 0.9% CeO, and the proportion of FeO content being 23.5% are used.

Said UV cut green glasses is preferred to have the light properties (when having 2.0 mm thickness) of:
visible light transmittance (YA): 80-86%,
solar radiation transmittance (TG): 55-76%
ultraviolet transmittance (Tuv): 10-25%.
   The method and conditions for manufacturing these UV cut green glasses are the same as the common method and conditions for manufacturing float glasses; as an example, blended glass material is melted at about 1500° C. to obtain a homogenius glass, then poured into a float bath, formed and shaped, cooled slowly and cut into a specified width. In the method of composition analysis of the UV cut green glass, the analysis is carried out with a fluorescent X-ray and the FeO amount is computed based on the light absorbance of the glass and the absorbancy index of FeO.

Said UV cut green glass containing iron is preferably used as at least one of the multiple glass plates constituting the laminated glass. The UV cut green glass preferably contains total iron content in the range of 0.6 to 1.2% by weight in terms of Fe₂O₃, and FeO in terms of Fe₂O₃ in the range of 15 to 40% based on the total iron, and more preferably, total iron content in the range of 0.7 to 0.8% by weight in terms of Fe₂O₃, and FeO in terms of Fe₂O₃ in the range of 25 to 30% based on the total iron.

The total iron content and the FeO proportion are chosen as described above because, with a smaller total iron content and FeO proportion, the solar radiation shielding performance would decrease, and, with a greater total iron content and FeO proportion, visible light transmittance would decrease, failing to satisfy 70%. In addition, with a smaller FeO proportion and a greater total iron content, the transmitted light becomes yellow-tinged, while with a greater FeO proportion it will be difficult to melt the glass material.

The plate thickness of the UV cut green glass is preferably in the range of 1.4 to 2.5 mm. Said thickness being smaller than 1.4 mm, glass strength would decrease, and the sight through distortion of the glass plate would become worse. On the other hand, said thickness being larger than 2.5 mm, visible light transmittance would decrease, failing to achieve the required extent of visible light transmittance. More preferably, as the laminated glass is required to have visible light transmittance of at least 70%, each of the glass plates in the laminated glass may be determined appropriately, so that the total thickness of the glass plates does not exceed the upper limit of 4.3 mm. As an example of dimensions of glass plate thickness, the combination of 2.5 mm and 1.8 mm can be suggested.

### EMBODIMENT 1

Step 1: To a PVB resin of 100 weight parts was added an plasticizer (3GH: triethyleneglycol-di-ethylbutylate) of 40 weight parts containing ITO microparticles of 0.21 wt %, to be kneaded and mixed therein in a roll mixer, together with other materials such as a ultraviolet absorber at the temperature of about 80° C. and for 30 minutes. The resin material obtained in this way was melted at about 200° C. and formed with a casting machine into a film having 0.76 mm thickness.

Step 2: A UV cut green glass having the thickness of 2 mm and the size of 300 mm □, manufactured by Nippon Sheet Glass Co., Ltd. was prepared, and the mating face was cleansed with purified water and dried naturally. The interlayer provided in Step 1 was then interposed between the two glass plates, and, holding the same condition, these were heated to 80° C. and bonded with pressure by a roll, and further heated and bonded with pressure in a pressure vessel at 14 kgf/cm² and 140° C. A laminated glass was obtained in this way.

Step 3: A part of the laminated glass, 100 mm □ in size, was clipped from the laminated glass obtained in Step 2, and measured in its spectral transmission factor in the range of 300 to 2500 nm wavelength with a spectrophotometer (UV3101PC, manufactured by Shimadzu Corporation). The visible light transmittance, solar radiation transmittance and transmittance at 1500 nm wavelength were obtained, based on the measured values. The haze value was measured by a haze meter manufactured by Suga Test Instruments Co., Ltd.

More specifically, the spectral transmission factor was measured by a spectrophotometer (UV3101PC, manufactured by Shimadzu Corporation) in the range of 300 to 2500 nm wavelength, the visible light transmittance was obtained using the light source A defined in JISZ8722, and the solar radiation transmittance by using the computing method of solar radiation transmittance defined in JISR3106. The transmittance at 1500 nm wavelength was obtained by directly reading the value indicated in the spectrophotometer. The haze value was measured as defined in JISR3212 by a haze computer manufactured by Suga Test Instruments Co., Ltd.

Step 4: A part of the interlayer, 50 mm □ in size, was clipped and dissolved in an appropriate solvent, and the quantity was determined of In and Sn using ICP, and the amount of the ITO microparticle content was obtained. More specifically, the clipped interlayer was dissolved by using acid and the Sn and In contents in the dissolvent were determined by using the plasma emission spectrometry method.

### EMBODIMENT 2

The ITO amount in embodiment 1 was changed to 0.5 g/m² in embodiment 2. For this purpose, in Step 1 in embodiment 1, to the PVB resin of 100 weight parts was added an plasticizer (3GH: triethyleneglycol-di-ethylbutylate) of 40 weight parts containing ITO microparticles of 0.15 wt %, to be kneaded and mixed therein in a roll mixer, together with other materials such as a UV absorber at about 80 C and for 30 minutes. The resin material thus obtained was melted at about 200 C to be formed into a film having 0.76 mm thickness. Steps 2 to 4 were carried out in the same way as in embodiment 1.

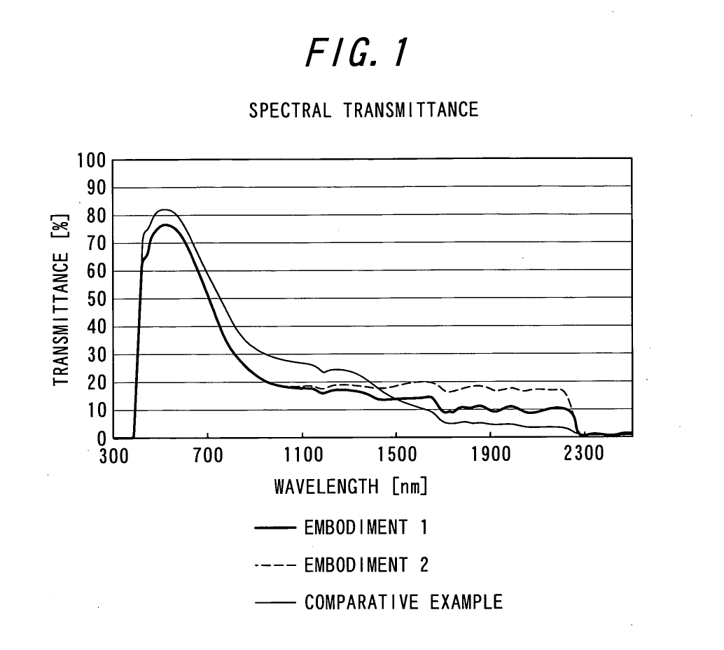

A laminated glass as a comparative example was obtained by using an plasticizer containing ITO microparticle content of 0.36 wt % and green glasses manufactured by Nippon Sheet Glass Co., Ltd, and, other conditions being the same as in embodiment 1, measurement was conducted. The results of measurement in the embodiments and the comparative example are shown in Table 1, while the spectral transmission factors are illustrated in FIG. 1

TABLE 1

| | Glass | Visible light | Solar radiation | Transmittance | Haze | ITO |
|---|---|---|---|---|---|---|
| | composition | transmittance (%) | transmittance (%) | at 1,500 n (%) | (%) | Content (g/m²) |
| Embodiment 1 | UV green | 72.6 | 39.8 | 14.3 | 0.2 | 0.7 |
| | glass 2 mm + | | | | | |
| | UV green | | | | | |
| | glass 2 mm | | | | | |
| Embodiment 2 | UV green | 73.0 | 41.4 | 19.5 | 0.1 | 0.5 |
| | glass 2 mm + | | | | | |
| | UV green | | | | | |
| | glass 2 mm | | | | | |
| Comparative | green glass | 77.4 | 45.4 | 13. | 0.4 | 1.2 |
| Example 1 | 2 mm + green | | | | | |
| | glass 2 mm | | | | | |

It is clear from Table 1 that the haze value in the laminated glass can be 0.4% or less and the transmittance at 1500 nm wavelength 20% or less, while visible light transmittance for the standard light source A is 70% or more. Thus, in the laminated glass according to the present invention, it is possible to lessen the solar radiation transmittance and the transmittance at 1500 nm wavelength and to prevent haze with smaller proportions of dispersed ITO microparticle content while visible transmittance remains high.

### OTHER EMBODIMENTS

In the embodiments explained above, the laminated glass comprises an interlayer consisting of a single layer. However, the present invention can also be applied to an interlayer having a three-layer constitution with an improved sound insulation performance. Among three-layer sound insulation interlayers, an interlayer having a three-layer constitution of a PVB resin layer, a sound insulation layer and a PVB resin layer is known. A three-layer interlayer can be obtained by dispersing ITO microparticles, 0.8 g/m² or less in total, in at least one of the PVB resin layers included in the interlayer. By interposing this interlayer between two UV cut green glasses, a laminated glass can be obtained.

### INDUSTRIAL APPLICABILITY

According to the present invention, it is possible to provide a laminated glass that excels in an infrared radiation shielding performance, exhibits high transparency, and is available at low cost even in the use of ITO particles as infrared radiation shielding microparticles.

1. A heat-shielding laminated glass comprising:
a plurality of glass plates, each thereof is a UV cut green glass of 1.4 to 2.5 mm thickness, total iron content thereof being in the range of 0.6 to 1.2% by weight in terms of Fe₂O₃, the green glass containing FeO in an amount of 15 to 40% in terms of Fe₂O₃ based on the total iron; and
an interlayer interposed between said glass plates, which contains ITO microparticles with an average particle diameter of 0.2 μm or less dispersed therein, said ITO microparticles amounting to 0.4 to 0.8 g/m².

2. The heat-shielding laminated glass according to claim 1, wherein total iron content is in the range of 0.7 to 0.8% by weight in terms of Fe₂O₃, and FeO content is in the range of 25 to 30% in terms of Fe₂O₃ based on the total iron.

3. The heat-shielding laminated glass according to claim 1 or 2, wherein said interlayer comprises a vinyl-based resin.

4. The heat-shielding laminated glass according to claim 3, wherein the haze value in said laminated glass is 0.4% or less, the transmittance at 1500 nm wavelength is 20% or less, and the visible light transmittance for the standard light source A is 70% or more.

5. The heat-shielding laminated glass according to claim 3, wherein said interlayer comprises:
two polyvinylbutyral layers, at least one thereof contains said ITO microparticles dispersed therein, wherein said ITO microparticles amounts to 0.4 to 0.8 g/m² in total in said interlayer; and
a sound-insulation layer interposed between said two polyvinylbutyral layers.
